(19) United States
(12) Patent Application Publication
(10) Pub. No.: US 2026/0059315 A1
(43) Pub. Date: Feb. 26, 2026

(54) SECURE ARCHITECTURE FOR DEVICE SHARE REQUESTS

(71) Applicant: Google LLC, Mountain View, CA (US)

(72) Inventors: Nathan Sandland, Mountain View, CA (US); Kevin Coppock, Huntsville, AL (US); Alexander Crettenand, San Mateo, CA (US); Kevin Po, San Francisco, CA (US); Alexei Sakhartchouk, Waterloo (CA)

(73) Assignee: Google LLC, Mountain View, CA (US)

(21) Appl. No.: 19/102,602

(22) PCT Filed: Aug. 30, 2023
(86) PCT No.: PCT/US2023/031485

§ 371 Date: Feb. 10, 2025

Related U.S. Application Data
(60) Provisional application No. 63/402,154, filed on Aug. 30, 2022.

(51) Int. Cl. H04W 12/086; H04L 9/40

(52) U.S. Cl. CPC H04W 12/086; H04L 63/107

(57) ABSTRACT

Various arrangements for sharing access to a smart home device are presented herein. A control device can receive, from a requesting application being executed on the control device, a credential share request, wherein the credential share request comprises zero, one, or more than one smart home device filter characteristics. The control device can determine one or more smart home devices that match the one or more smart home device filter characteristics from the credential share request. In response to determining one or more smart home devices match the one or more smart home device filter characteristics, the control device can request user input indicating that access credentials for the one or more smart home devices is authorized to be shared with the requesting application. In response to consenting user input, access credentials can be provided to the requesting application.

### CROSS-REFERENCE TO RELATED APPLICATION

This application claims the benefit of and priority to U.S. Provisional Application No. 63/402,154, filed on Aug. 30, 2022, and titled “SECURE ARCHITECTURE AND PROGRAM FLOW FOR MATTER SHARE REQUEST API,” the content of which is herein incorporated by reference in its entirety for all purposes.

### BACKGROUND

With some protocols it can be possible for a control device to share credentials corresponding to a target device with an application executing on the control device that did not previously have access to controlling the target device. While such an ability of an application can be highly beneficial to a user, such as by saving the user from having to manually provide credentials to the application, such an ability has the potential to be exploited as a security vulnerability.

### SUMMARY

Various embodiments are described related to a method for sharing access to a smart home device. In some embodiments, a method for sharing access to a smart home device is described. The method may comprise receiving, by an operating system of a control device from a requesting application being executed on the control device, a credential share request. The credential share request may comprise one or more smart home device filter characteristics. The method may comprise determining, by the operating system of the control device, one or more smart home devices that match the one or more smart home device filter characteristics from the credential share request. The method may comprise in response to determining the one or more smart home devices match the one or more smart home device filter characteristics, requesting, by the operating system of the control device, user input indicating that access credentials for the one or more smart home devices is authorized to be shared with the requesting application. The method may comprise in response to the user input, providing the access credentials to the requesting application.

Embodiments of such a method may include one or more of the following features: no response may be provided by the operating system to the requesting application in request to the credential share request until after user input is received. The method may further comprise receiving, by the requesting application, the access credentials. The method may further comprise transmitting, a command message to a smart home device of the one or more smart home devices by the requesting application using the access credentials. The one or more smart home device filter characteristics of the credential share request may identify a device type. The one or more smart home device filter characteristics of the credential share request may identify a vendor. The one or more smart home device filter characteristics of the credential share request may identify a specific smart home device. The method may comprise prior to receiving the credential share request from the requesting application, receiving, by the operating system, the access credentials to be used by a second application. The method may comprise storing, by the operating system of the control device, the access credentials. The one or more smart home devices may comprise multiple smart home devices and the access credentials provided to the requesting application include access credentials for the multiple smart home devices. The method may comprise receiving, by the operating system of the control device from a second requesting application being executed on the control device, a second credential share request. The second credential share request may comprise one or more smart home device filter characteristics. The method may comprise determining, by the operating system of the control device, that no smart home devices for which credentials are stored match the one or more smart home device filter characteristics from the second credential share request. The method may comprise ignoring, by the operating system of the control device, the second credential share request. The access credentials may allow for control of the one or more smart home devices to be performed using the Matter connectivity standard.

In some embodiments, a control device is described. The device may comprise a wireless communication interface. The device may comprise a display. The device may comprise one or more processors. The device may comprise a memory communicatively coupled with and readable by the one or more processors and having stored therein processor-readable instructions which, when executed by the one or more processors, cause the one or more processors to receive, from a requesting application being executed on the control device, a credential share request. The credential share request may comprise one or more filter characteristics. The one or more processors may determine one or more smart home devices that match the one or more filter characteristics of the filter from the credential share request. The one or more processors in response to determining the one or more smart home device match the one or more filter characteristics, request, via the display, user input indicating that access credentials for the one or more smart home devices may be authorized to be shared with the requesting application. The one or more processors in response to the user input, provide the access credentials to the requesting application.

Embodiments of such a device may include one or more of the following features: no response may be provided to the requesting application in request to the credential share request until after user input is received. The device may further comprise the requesting application. The requesting application may be configured to receive the access credentials. The requesting application may be configured to output a command message to a smart home device of the one or more smart home devices by the requesting application using the access credentials. The one or more smart home device filter characteristics of the credential share request may identify a device type. The device may further comprise a second application executed by the control device. The processor-readable instructions, which, when executed by the one or more processors, may further cause the one or more processors to prior to receiving the credential share request from the requesting application, receive the access credentials to be used by a second application. The processor-readable instructions, which, when executed by the one or more processors, may further cause the one or more processors to store the access credentials. The processor-readable instructions, which, when executed by the one or more processors, further cause the one or more processors to receive, from a second requesting application being executed on the control device, a second credential share request. The second credential share request may comprise one or more smart home device filter characteristics. The one or more processors may determine that no smart home devices for which credentials are stored match the one or more smart home device characteristics of the second credential share request. The one or more processors may ignore the second credential share request such that no response is provided to the requesting application.

In some embodiments, a non-transitory processor-readable medium is described. The medium may comprise processor-readable instructions configured to cause one or more processors to receive, from a requesting application being executed on a control device, a credential share request. The credential share request may comprise one or more smart home device filter characteristics. The one or more processors may determine one or more smart home devices that match the one or more smart home device filter characteristics from the credential share request.

The one or more processors, in response to determining the one or more smart home device match the one or more smart home device filter characteristics, may request user input indicating that access credentials for the one or more smart home devices is authorized to be shared with the requesting application. The one or more processors, in response to the user input, may provide the access credentials to the requesting application. No response may be provided to the requesting application in request to the credential share request until after user input is received. The one or more smart home device filter characteristics of the credential share request may identify a device type. The processor-readable instructions may be further configured to cause the one or more processors to receive, from a second requesting application being executed on the control device, a second credential share request. The second credential share request may comprise one or more smart home device filter characteristics. The one or more processors may determine that no smart home devices for which credentials are stored match the one or more smart home device characteristics of the second credential share request. The one or more processors may ignore the second credential share request such that no response is provided to the requesting application.

### BRIEF DESCRIPTION OF THE FIGURES

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a block diagram of a system that uses a secure architecture for share requests.

FIG. 2 illustrates an embodiment of a method for controlling access to smart home devices via share requests.

FIG. 3 illustrates another embodiment of a method for controlling access to smart home devices via share requests.

FIG. 4 illustrates an embodiment of a user interface for controlling access to smart home devices in response to a share request.

FIG. 5 illustrates another embodiment of a user interface for controlling access to smart home devices in response to a share request.

### DETAILED DESCRIPTION

While the ability to easily share credentials in order to access and control smart home devices among multiple applications is convenient for a user, such an arrangement can present security concerns. In some situations, a requesting application (that is, the application that is attempting to acquire the credentials of smart home devices) can discover what smart home devices are available to be controlled by a control device (e.g., a smartphone) of a user. For example, a nefarious actor could create a requesting application to discover what smart home devices are already configured for control by the user. Even if a user blocks actual control of the smart home devices by the requesting application, information indicative of the number, vendor, and/or type of smart home devices may be used for purposes other than legitimate control of smart home devices. For example, knowing what smart home devices a user has installed without the user's permission could be used for competitive purposes (e.g., targeted advertising) or for identifying devices that have security vulnerabilities. Further, revealing the number and types of smart home devices installed would likely be seen by a user as an invasion of privacy.

Additionally or alternatively, the embodiments detailed herein can help prevent confusion with a user by ensuring that access is requested to only smart home devices that make sense to be controlled by a requesting application, such as smart lights by a lighting control application.

To address this potential security and privacy vulnerability, arrangements detailed herein prevent any information about smart home devices from being shared with a requesting application unless explicitly authorized by the end user of the control device. As detailed herein, when a requesting application requests credentials from an operating system (or other component or system that possesses administrative rights to access multiple devices) of a control device, the request can be required to include a filter. The filter can be used to define characteristics of the device which the requesting application can control or otherwise interact with. The filter can be defined based on characteristics such as vendor and device type. In response to the request including the filter, the operating system of the control device may first determine which, if any smart home devices, which the control device is already authorized to control or interact, matches the characteristics of the filter. If no matches are present, no action (e.g., no response to the requesting application) may be taken by the control device. If one or more matches are present, a user interface can be presented requesting permission from a user as to whether credentials for one, some, or all of the matching smart home devices should be provided to the requesting application. Only if the user provides approval does the requesting application receive a response from the operating system. This response would include credentials for the approved smart home devices. From the requesting application's perspective, when no response is received, the requesting application cannot determine if no smart home device matches the criteria or the user denied the request.

Further detail regarding these and other embodiments is provided in relation to the figures. While the arrangements detailed herein can be applied to various communication protocols, these arrangements may be specifically useful in relation to the open standard Matter used for smart home device control across various vendors and manufacturers. Further, the embodiments detailed herein focus on smart home devices, however other forms of network-connected devices can also be controlled via such embodiments.

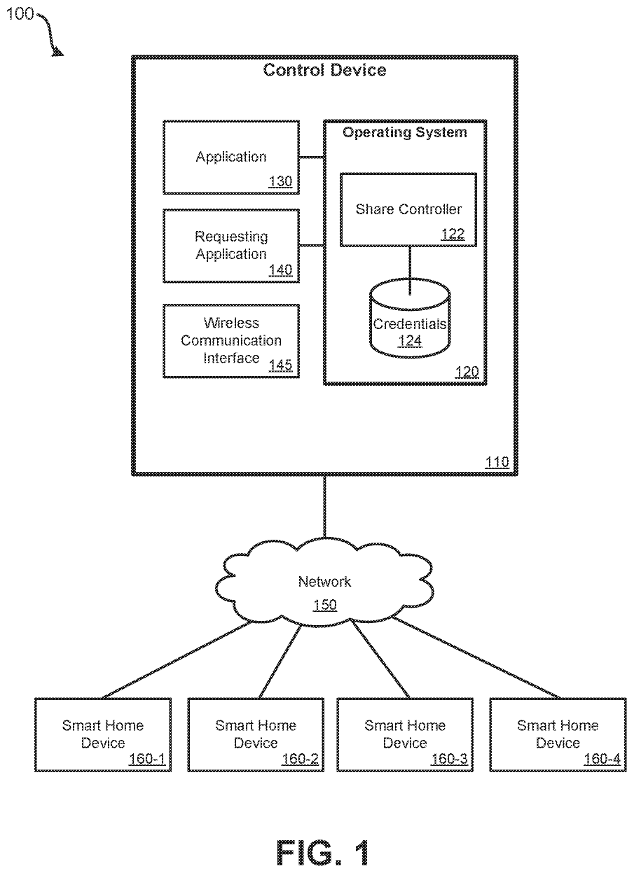

FIG. 1 illustrates a block diagram of a system 100 that uses a secure architecture for share requests, such as for share requests performed for one or more smart home devices that use the Matter standard for communication and connectivity. System 100 can include: control device 110, network 150, and smart home devices 160 (160-1, 160-2, 160-3, and 160-4). Control device 110 can be a device which a user uses to control one or more smart home devices 160 in an environment. Control device 110 can be a smartphone, a tablet computer, a home assistant device, a gaming device, smart television, a streaming or casting device that connects with a display device, a laptop computer, desktop computer, or some other computerized device that allows for execution of various installed applications.

System 100 can also include network 150. Network 150 can be a wireless local area network that is hosted by a router or other form of access point. Network 150 can allow for IP-based communication using one or more protocols. For example, network 150 can use an IEEE 802.11 (e.g., WiFi™) standard for wireless communication. Additionally or alternatively, network 150 can perform Matter-specific wireless communications using a communication protocol separate from the IEEE 802.11 suite of protocols.

System 100 can include one or more smart home devices 160. Such smart home devices can be capable of operating in accordance with the Matter communication protocol. As illustrated, four smart home devices 160 are illustrated. This number is an example only. Embodiments detailed herein apply to arrangements including one or more than one smart home devices.

Examples of possible smart home devices 160 can include: smart lightbulbs; smart lights; smart switches; smart garage door openers; home assistant devices; smart outlets; smart hazard detectors (e.g., smart smoke and/or carbon monoxide detectors); smart thermostats; smart televisions; network-enabled sensors; smart doorbells; smart video cameras; alarm systems; Internet of Things (IoT) devices; network-enabled heating ventilation and air conditioning (HVAC) systems; etc.

Such smart home devices 160 can be sold by various vendors, made by various manufacturers, and/or of various types. As an example, one embodiment may involve a single smart lightbulb being the only smart home device 160. As another example, one embodiment may involve dozens of devices including smart lightbulbs, security cameras, a smart doorbell, and smart outlets, of which some may be made or sold by different manufacturers or vendors.

Control device 110 includes a processing system (not illustrated), which includes one or more processors, capable of executing software. Control device 110 further can include wireless communication interface 145 that allows for wireless communication with network 150, such as using an IEEE 802.11 protocol and/or Matter. Control device 110 executes operating system 120. For example, for Android-based devices, operating system 120 may be Android, which can include Google™ Play Services™ that allows for acquisition and interaction with various applications. Control device 110 further has installed at least one application, referred to as requesting application 140.

In some embodiments, control device 110 presently or previously had application 130 installed, which can be an application which has been authorized to control and/or interact with smart home devices 160. In a Matter related embodiment, a Matter fabric has been previously created that authorizes application 130 to interact with smart home devices 160. In the process of creating this Matter fabric, credentials that allow for additional applications to control and/or interact with smart home device 160 are acquired by operating system 120 and are stored to credentials datastore 124. Credentials datastore 124 is stored locally to a non-transitory processor-readable medium. In some embodiments, such credentials can be stored remotely, such as to a cloud-based storage arrangement accessible via the Internet. In other embodiments, it is possible that application 130 was part of a Matter fabric that was only authorized to interact or control a subset of smart home devices 160 and credentials for other smart home devices of smart home devices 160 were obtained by operating system 120 via configuration of some other application or have been imported from some other device. In some embodiments, a component other than operating system 120 may possess the administrative rights to access credentials datastore 124 that permits access to multiple devices. For example, an installed application that possesses permission to access credential datastore 124.

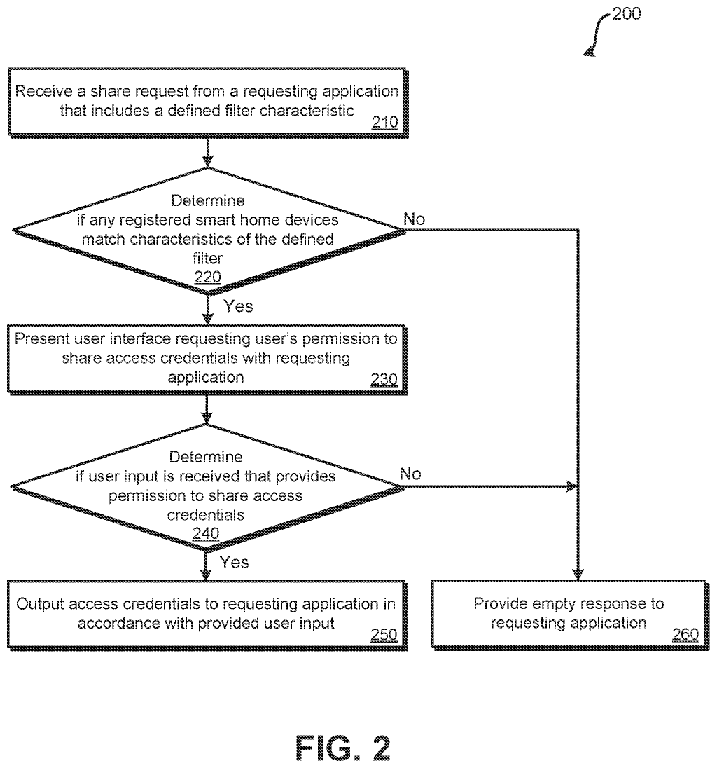

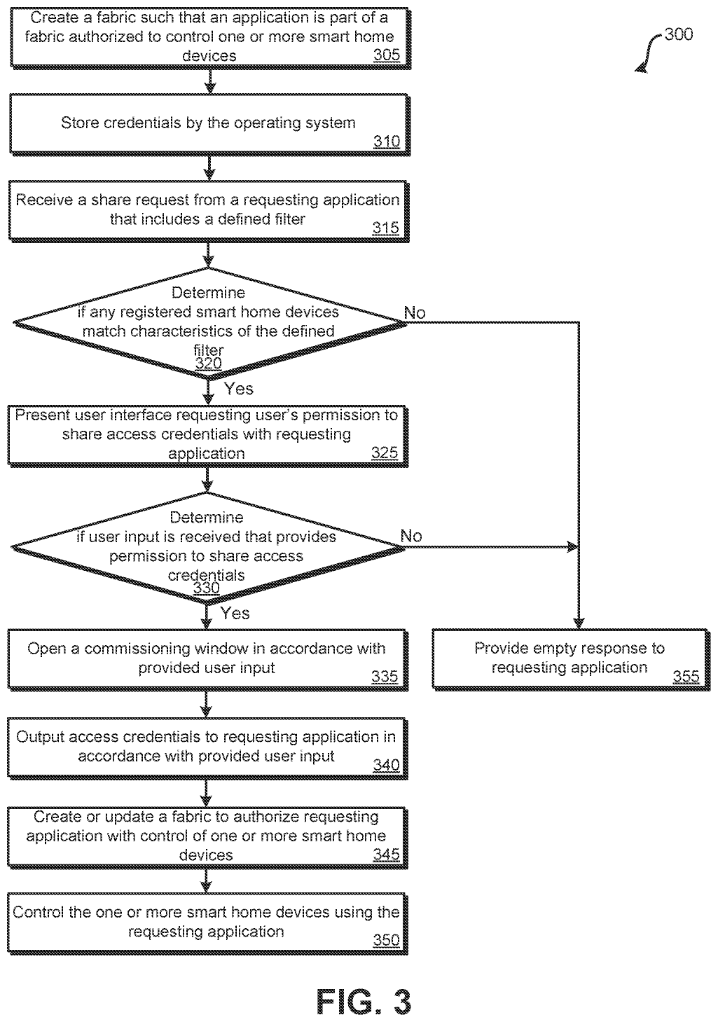

At some future time, a user may desire to use an additional or alternative application to control some or all of smart home devices 160. The user may download the application on control device 110, such as from an application (“app”) store, such as Google™ Play Store. This application is referred to herein as “requesting” application 140 because it will perform a request for smart home device credentials. Rather than a user manually providing credentials to requesting application 140, requesting application 140 can output a credential sharing request, which includes a filter defining one or more characteristics of smart home devices that it desires to interact with, to operating system 120. This credential sharing request can be submitted in the form of an application programming interface (API) request. Further detail regarding the credential sharing request is provided in relation to FIG. 2 and FIG. 3.

Operating system 120, in addition to managing credentials datastore 124, can include share controller 122. Share controller 122 handles received credential sharing requests, such as such a request from requesting application 140. Share controller 122 performs several functions, including: determining which smart home devices match the characteristics defined in a filter included in a credential sharing request; prompting a user to provide permission if one or more devices match the characteristics; and providing a response to the requesting application. Further detail regarding such functions is provided in relation to the method of FIGS. 2 and 3.

FIG. 2 illustrates an embodiment of a method 200 for controlling access to smart home devices via share requests. Method 200 may be performed using system 100 of FIG. 1. More specifically, each block of method 200 can be performed by operating system 120 of FIG. 1. (In other embodiments, a component other than an operating system of the control device can perform the blocks of method 200. For example, an authorized application can control sharing of credentials.) At block 210, the operating system (or other component managing the sharing of credentials) receives a credential share request from a requesting application. The credential share request defines one or more filter characteristics. The filter characteristics can be performed in accordance with Boolean algebra, such that a smart home device having a characteristic is either “true” or “false.” Possible characteristics can include: vendor/manufacturer; product; device type; and/or a definition of a specific device. Filtering by product can be done based on the “product identifier (ID), which for Matter, can be referred to as the Matter PID (Product ID). The Vendor ID (VID) can be specified to filter to a particular manufacturer. The PID can be specified in addition to the VID to further filter the result (e.g. a particular product by a particular manufacturer or vendor). Additional or alternative characteristics are possible. As an example, filter characteristics could define that the requesting application is requesting the sharing of credentials for any available smart lightbulbs (a device type). As another example, filter characteristics could define that the requesting application is requesting the sharing of credentials for all devices manufactured by a particular company.

Additionally or alternatively, such as for Matter, a unique ID may be used, which is part of Matter's basic information cluster. A unique ID can be optionally provided by the manufacturer as a property on the device that is unique to a particular device. In some embodiments, zero filter characteristics are permitted to be defined, thus allowing a user to determine whether credentials for all smart home devices should be shared with the requesting application.

Notably, filter characteristics can also be defined to exclude particular devices from matching the filter characteristics. For example, if a smart light bulb has already had its credentials provided to the requesting application, the requesting application may specifically exclude this light bulb from matching the defined filter characteristics that are intended to capture other smart light bulbs. This arrangement may be particularly useful to prevent confusion of the end user, such that the end user is not being requested to provide access to credentials for smart home devices that the end user has previously provided. If a requesting application wants to filter out one or more smart home devices which it already has access to (and which provided a Unique ID), one or more filter characteristics can be defined to exclude such devices matching the provided one or more unique IDs from being captured by the filter.

At block 220, the operating system (or other component managing the sharing of credentials) can determine if any previously registered smart home device for which credentials are stored matches the one or more filter characteristics of the request. If no, method 200 proceeds to block 260. If yes, method 200 proceeds to block 230.

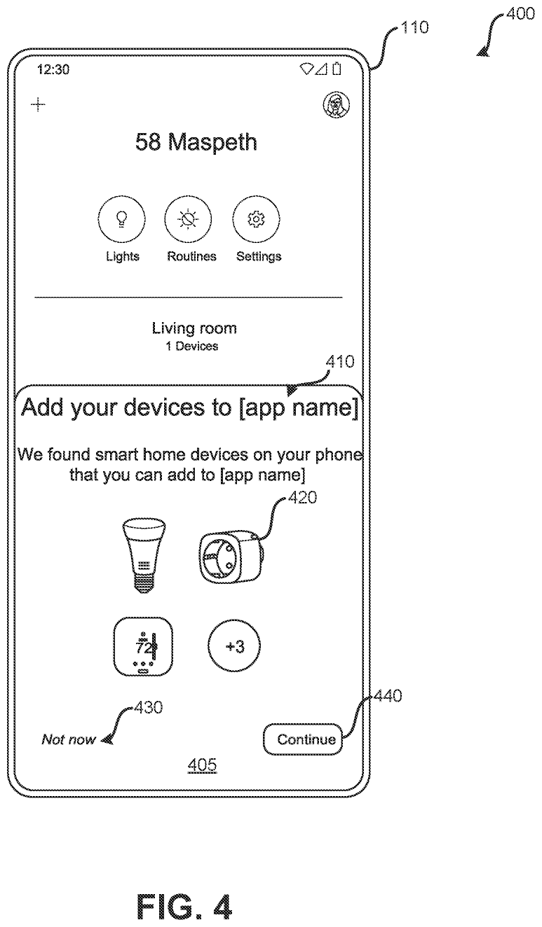

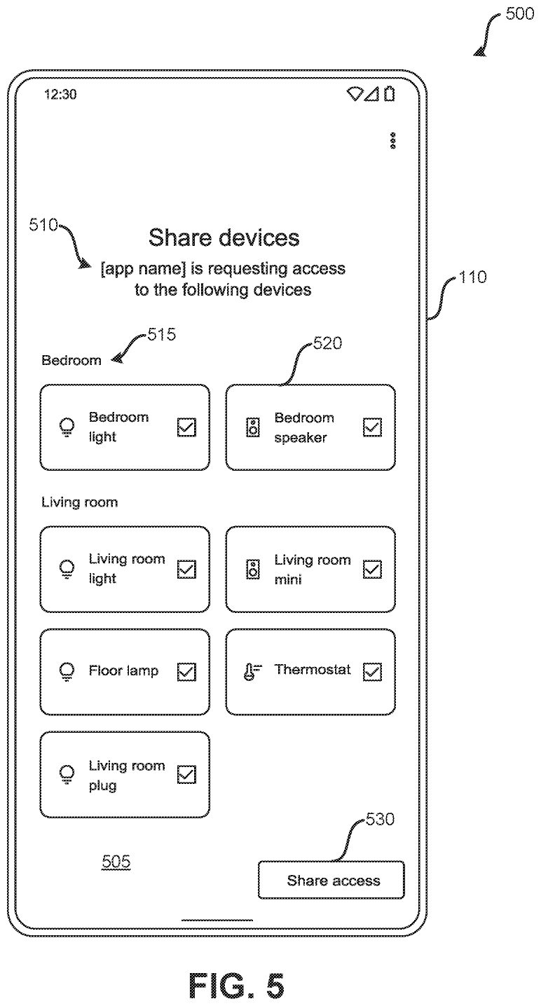

At block 230, one or more user interfaces are presented or otherwise output that requests input from a user to authorize the sharing of credentials. At block 230, no substantive response has been provided to the requesting application. Particularly, no response has been provided to the requesting application indicating whether or not an available smart home device matches the filter criteria. In some embodiments, the user interface may be visual, such as the examples presented in relation to FIGS. 4 and 5. In other embodiments, user input is solicited in a different form. For example, a spoken message may request sharing and identify the relevant devices. A user could then respond verbally to the control device. Other arrangements may use gestures as the form of user input.

At block 240, a determination is made as to whether the user approved the sharing of credentials. The user has the options of: approving the sharing for all smart home devices that match the filter characteristics; if multiple smart home devices match the filter characteristics, approving the sharing for a subset of the smart home devices that match the filter characteristics; or denying the sharing request for all smart home devices that match the filter characteristics. If the user denies the sharing request for all smart home devices that match the filter characteristics, method 200 proceeds to block 260. If the user approves the sharing request for some or all smart home devices that match the filter characteristics, method 200 proceeds to block 250.

At block 250, access credentials are provided by the operating system to the requesting application for only the smart home devices indicated by the user input. From the perspective of the requesting application, the requesting application is unaware if the provided credentials correspond to all smart home devices matching the filter characteristics or if the user selected a subset of smart home devices that match the filter characteristics. Along with the credentials, additional information about each selected smart home device may be provided, such as manufacturer, model, capabilities, etc. Block 250 may be performed as an API response that is provided in response to the API call of the sharing request.

At block 260, an empty response or no response may be provided to the requesting application. From the perspective of the requesting application, the requesting application cannot determine whether there were no smart home devices matching the filter characteristics or that there was at least one match, but the user denied the sharing request. In some embodiments, rather than proving no response to the requesting application, an empty or null response, or a negative response (which does not specify the reason for the negative response) may be provided instead. If such a response is to be provided following block 220, a random time delay may be used prior to the negative response being delivered such that it is not possible to determine whether a user was involved in the response.

Method 200 may be performed multiple times, either for different requesting applications or for the same requesting application with different filter criteria. For example, the user may desire a second or third requesting application to be installed and authorized to control smart home devices. As another example, the same requesting application may make multiple requests using different filter characteristics.

FIG. 3 illustrates an alternative embodiment of a method 300 for controlling access to smart home devices via share requests. Method 300 is specifically directed to an implementation in accordance with the Matter communication protocol used for smart home devices. Method 300 can be performed using an embodiment of system 100 of FIG. 1.

At block 305, a Matter fabric may be created or updated such that an application is included that is authorized to control one or more smart home devices. Block 305 may involve a user manually entering credentials that permit access to a particular one or more smart home devices. At block 310, as part of the fabric creation or update process, the credentials necessary to control or interact with the smart home device can be stored by the operating system (or some other authorized software component). Subsequently, the application of block 305 may be uninstalled or may remain installed on the control device on which the operating system is executed.

At block 315, the operating system (or other component managing the sharing of credentials) receives a credential share request from a requesting application, which is separate and distinct from the application of block 305. The credential share request defines one or more filter characteristics. The filter characteristics can be as defined in relation to block 210. In some embodiments, zero filter characteristics are permitted to be defined, thus allowing a user to determine whether credentials for all smart home devices should be shared with the requesting application.

At block 320, the operating system (or other component managing the sharing of credentials) can determine if any previously registered smart home device for which credentials are stored matches the one or more filter characteristics of the request. If no, method 300 proceeds to block 355. If yes, method 300 proceeds to block 325. In some embodiments, as part of block 320, a throttling analysis may also be performed. A throttling analysis can involve determined by the operating system (or other component) that the requesting application has not exceeded a defined number of requests in a defined period of time. If an excess number of requests has occurred, method 300 can proceed to block 355.

At block 325, one or more user interfaces are presented or otherwise output that requests input from a user to authorize the sharing of credentials. At block 325, no substantive response has been provided to the requesting application. Particularly, no response has been provided to the requesting application indicating whether or not an available smart home device matches the filter criteria. In some embodiments, the user interface may visual, such as the examples presented in relation to FIGS. 4 and 5. In other embodiments, user input is solicited in a different form. For example, a spoken message may request sharing and identify the relevant devices. A user could then respond verbally to the control device. Other arrangements may use gestures as the form of user input.

At block 330, a determination is made as to whether the user approved the sharing of credentials. The user has the options of: approving the sharing for all smart home devices that match the filter characteristics; if multiple smart home devices match the filter characteristics, approving the sharing for a subset of the smart home devices that match the filter characteristics; or denying the sharing request for all smart home devices that match the filter characteristics. If the user denies the sharing request for all smart home devices that match the filter characteristics, method 300 proceeds to block 355. If the user approves the sharing request for some or all smart home devices that match the filter characteristics, method 300 proceeds to block 335.

At block 335, for each smart home device for which sharing was approved by the user, a commissioning window is opened at the respective smart home devices. Block 335 involves a message being transmitted to each smart home device for which sharing was approved that triggers opening of the commissioning window. Within a defined amount of time, the requesting application can then either be added to a Matter fabric or create a new Matter fabric that will enable control or interaction between the requesting application and the one or more approved smart home devices.

At block 340, access credentials are provided by the operating system to the requesting application for only the smart home devices indicated by the user input. From the perspective of the requesting application, the requesting application is unaware if the provided credentials correspond to all smart home devices matching the filter characteristics or if the user selected a subset of smart home devices that match the filter characteristics. Along with the credentials, additional information about each selected smart home device may be provided, such as manufacturer, model, capabilities, etc. Block 340 may be performed as an API response that is provided in response to the API call of the sharing request.

At block 345, one or more Matter fabrics can be updated or created using the provided credentials such that the requesting application is now approved to control the smart home devices for which sharing was approved by the user. At block 350, the requesting application, using the updated or new Matter fabrics, can interact with or control the smart home devices for which sharing was approved by the user.

At block 355, an empty or no response may be provided to the requesting application.

From the perspective of the requesting application, the requesting application cannot determine whether there were no smart home devices matching the filter characteristics or that there was at least one match, but the user denied the sharing request. In some embodiments, rather than proving no response to the requesting application, an empty or null response, or a negative response (which does not specify the reason for the negative response) may be provided instead. If such an empty response is to be provided following block 320, a random time delay may be used prior to the negative response being delivered such that it is not possible to determine whether a user was involved in the response.

FIG. 4 illustrates an embodiment 400 of a user interface 405 for controlling access to smart home devices in response to a share request. On control device 110, user interface 405 can be presented if at least one smart home device matches filter characteristics provided by the requesting application as part of a credential share request. User interface 405 can indicate name 410 of the requesting application. Icons 420 may be presented to give the user an idea of the type of smart home devices which match the filter characteristics. In the example illustrated, a lightbulb, a smart outlet, a thermostat, and three other devices match the filter characteristics. If the user wants to deny the request outright, the user can select element 430. If the user is interested in proceeding, the user can select element 440.

FIG. 5 illustrates an embodiment 500 of a user interface 505 for controlling access to smart home devices in response to a share request. On control device 110, user interface 505 can be presented if at least one smart home device matches filter characteristics provided by the requesting application as part of a credential share request. Alternatively, user interface 505 can be presented after a user has selected element 440 on user interface 405. User interface 505 can indicate name 510 of the requesting application. A user can select individual smart home devices from among those that match the filter characteristics. As illustrated, all matching smart home devices are selected. Each element, such as element 520, corresponds to a particular smart home device which can be selected or unselected. Each element, such as element 520 can include a name of the smart home device and/or a graphical indicator of the type of device. In some embodiments, smart home devices that meet the filter characteristics are organized by location 515 (e.g., room) in which the smart home devices are located. A user can select element 530 to share credentials once the desired selections have been made.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

1. A method for sharing access to a smart home device, the method comprising:
receiving, by an operating system of a control device from a requesting application being executed on the control device, a credential share request, wherein the credential share request comprises one or more smart home device filter characteristics;
determining, by the operating system of the control device, a plurality of smart home devices that match the one or more smart home device filter characteristics from the credential share request;
in response to determining the plurality of smart home device match the one or more smart home device filter characteristics, requesting, by the operating system of the control device, user input indicating whether access credentials for each of the plurality of smart home devices is authorized to be shared with the requesting application; and
in response to the user input, providing the access credentials for a subset of the plurality of smart home devices to the requesting application based on the user input, wherein
the requesting application is not made aware of smart home device of the plurality of smart home devices outside of the subset.

2. The method for sharing access to the smart home device of claim 1, wherein no response is provided by the operating system to the requesting application in request to the credential share request until after user input is received.

3. The method for sharing access to the smart home device of claim 2, further comprising:
receiving, by the requesting application, the access credentials; and
transmitting, a command message to a smart home device of the subset of the plurality of smart home devices by the requesting application using the access credentials.

4. The method for sharing access to the smart home device of claim 1, wherein the one or more smart home device filter characteristics of the credential share request identifies a device type.

5. The method for sharing access to the smart home device of claim 1, wherein the one or more smart home device filter characteristics of the credential share request identifies a vendor.

6. The method for sharing access to the smart home device of claim 1, wherein the one or more smart home device filter characteristics of the credential share request identifies a specific smart home device.

7. The method for sharing access to the smart home device of claim 1, further comprising:
prior to receiving the credential share request from the requesting application, receiving, by the operating system, the access credentials to be used by a second application; and
storing, by the operating system of the control device, the access credentials.

8. The method for sharing access to the smart home device of claim 1, wherein the subset of the plurality of smart home devices comprise multiple smart home devices and the access credentials provided to the requesting application include access credentials for the multiple smart home devices.

9. The method for sharing access to the smart home device of claim 1, further comprising:
receiving, by the operating system of the control device from a second requesting application being executed on the control device, a second credential share request, wherein the second credential share request comprises one or more smart home device filter characteristics;
determining, by the operating system of the control device, that no smart home devices for which credentials are stored match the one or more smart home device filter characteristics from the second credential share request; and
ignoring, by the operating system of the control device, the second credential share request.

10. The method for sharing access to the smart home device of claim 1, wherein the access credentials allow for control of the subset of the plurality of smart home devices to be performed using the Matter connectivity standard.

11. A control device, comprising:
a wireless communication interface;
a display;
one or more processors; and
a memory communicatively coupled with and readable by the one or more processors and having stored therein processor-readable instructions which, when executed by the one or more processors, cause the one or more processors to:
receive, from a requesting application being executed on the control device, a credential share request, wherein the credential share request comprises one or more filter characteristics;
determine a plurality of smart home devices that match the one or more filter characteristics of the filter from the credential share request;
in response to determining the plurality of smart home device match the one or more filter characteristics, request, via the display, user input indicating whether access credentials for each of the plurality of smart home devices is authorized to be shared with the requesting application; and
in response to the user input, provide the access credentials for a subset of the plurality of smart home devices to the requesting application based on the user input, wherein
the requesting application is not made aware of smart home device of the plurality of smart home devices outside of the subset.

12. The control device of claim 11, wherein no response is provided to the requesting application in request to the credential share request until after user input is received.

13. The control device of claim 11, further comprising the requesting application, wherein the requesting application is configured to:
receive the access credentials; and
output a command message to a smart home device of the subset of the plurality of smart home devices by the requesting application using the access credentials.

14. The control device of claim 11, wherein the one or more smart home device filter characteristics of the credential share request identifies a device type.

15. The control device of claim 11, further comprising a second application executed by the control device, wherein the processor-readable instructions, which, when executed by the one or more processors, further cause the one or more processors to:
prior to receiving the credential share request from the requesting application, receive the access credentials to be used by a second application; and
store the access credentials.

16. The control device of claim 11, wherein the processor-readable instructions, which, when executed by the one or more processors, further cause the one or more processors to:
receive, from a second requesting application being executed on the control device, a second credential share request, wherein the second credential share request comprises one or more smart home device filter characteristics;
determine that no smart home devices for which credentials are stored match the one or more smart home device characteristics of the second credential share request; and
ignore the second credential share request such that no response is provided to the requesting application.

17. A non-transitory processor-readable medium comprising processor-readable instructions configured to cause one or more processors to:
receive, from a requesting application being executed on a control device, a credential share request, wherein the credential share request comprises one or more smart home device filter characteristics;
determine a plurality of smart home devices that match the one or more smart home device filter characteristics from the credential share request;
in response to determining the plurality of smart home device match the one or more smart home device filter characteristics from the credential share request, request user input indicating whether access credentials for each of the plurality of smart home devices is authorized to be shared with the requesting application; and
in response to the user input, provide the access credentials for a subset of the plurality of smart home devices to the requesting application based on the user input, wherein
the requesting application is not made aware of smart home device of the plurality of smart home devices outside of the subset.

18. The non-transitory processor-readable medium of claim 17, wherein no response is provided to the requesting application in request to the credential share request until after user input is received.

19. (canceled)

20. The non-transitory processor-readable medium of claim 18, wherein the processor-readable instructions are further configured to cause the one or more processors to:
receive, from a second requesting application being executed on the control device, a second credential share request, wherein the second credential share request comprises one or more smart home device filter characteristics;
determine that no smart home devices for which credentials are stored match the one or more smart home device characteristics of the second credential share request; and
ignore the second credential share request such that no response is provided to the requesting application.
